(19) United States
(12) Patent Application Publication
(10) Pub. No.: US 2026/0097542 A1
(43) Pub. Date: Apr. 9, 2026

(54) AUTOMATIC KITCHEN COUNTERTOP DEVICE FOR CONVERTING RECYCLABLE BOTTLES INTO REDEEMABLE COINS OR TOKENS

(71) Applicant: Russell Javaruski, Lakewood, NJ (US)

(72) Inventor: Russell Javaruski, Lakewood, NJ (US)

(21) Appl. No.: 19/330,025

(22) Filed: Sep. 16, 2025

Related U.S. Application Data
(60) Provisional application No. 63/704,631, filed on Oct. 8, 2024.

(51) Int. Cl. B29B 17/00

(52) U.S. Cl. CPC B29B 17/0042; B29B 2017/001

(57) ABSTRACT

An automatic kitchen countertop device for converting recyclable bottles into redeemable coins or tokens includes a housing having an outer sidewall and an inner wall which defines a heating chamber for melting the recyclable bottles, a base mounted on a lower portion of the outer sidewall, a cover hingedly affixed to the outer sidewall, a heating element which provides heat to the heating chamber and a coin or token tray which receives molten plastic from melted bottles placed in the heating chamber, the molten plastic solidifying in the coin or token tray to form a coin or token which may be removed from the tray and redeemed for cash or credit.

### CROSS-REFERENCE TO RELATED APPLICATIONS

This application is related to U.S. Provisional Application Ser. No. 63/704,631, filed on Oct. 8, 2024, and titled “Device for Converting Recyclable Bottles into Redeemable Coins or Tokens”, the disclosure of which is incorporated herein by reference and on which priority is hereby claimed.

### BACKGROUND OF THE INVENTION

### Field of the Invention

The present invention generally relates to devices and methods for recycling plastic products to address environmental concerns, and more specifically relates to machines and apparatus used for recycling plastic bottles and containers commonly containing liquid refreshments, such as water and soft drink bottles, and to reduce the size of the products to a more manageable state for shipment to a recycling facility.

### Description of the Related Art

Many states require a retail establishment that sells to consumers liquid refreshments in plastic bottles or aluminum containers to charge a consumer an additional five or ten cents per product as a redeemable deposit in an effort to induce consumers to return the empty bottles or containers to the retail establishment where the products were purchased for recycling. The retail establishments, such as supermarkets, grocery stores and even food marts at automobile service stations, usually have one or more bottle and container compacting apparatus that accept empty containers returned by consumers and crush the plastic bottles and cans to a more manageable state for shipment to a recycling facility. The compacting device issues the consumer a ticket or receipt for the redeemable deposits based on the number of bottles or containers returned by the consumer and the deposit thereon. The consumer then takes the ticket or receipt to a cashier within the store for redemption as cash or credit toward new purchases. Such a bottle recycling program that requires individuals to return plastic bottles or cans to redemption centers or stores to receive monetary compensation or recycling credits is time consuming and requires excessive effort on the part of consumers. Consumers need to accumulate and store empty bottles and cans often in large trash bags, transport the bags of accumulated bottles to the redemption center, and wait in line for a bottle compactor to become available. This bottle redemption process is frustrating for the consumer to undertake, and oftentimes the consumer decides it is not worth the bother and discards the recyclable bottles as trash rather than redeeming the same for the deposits paid, which defeats the whole purpose of the recycling program.

### OBJECTS AND SUMMARY OF THE INVENTION

It is an object of the present invention to provide an automatic kitchen countertop device for converting recyclable plastic bottles into redeemable coins or tokens.

In one form, the present invention is directed to a device for transforming used liquid plastic bottles into coins or tokens. More specifically, the present invention simplifies the conventional bottle recycling process by allowing users to recycle plastic bottles at home, transforming them into redeemable tokens using a heat-melting process.

The device operates by heating the plastic bottles within an insulated chamber, melting the plastic material from which the bottles are formed, and allowing the viscous molten plastic to flow into a coin-shaped mold to form a token. Once the plastic cools, the token is ejected for easy retrieval. Optional features include material sensors, different melting cycles based on the material, and fraud prevention mechanisms such as RFID chips embedded in the tokens.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of a first embodiment of an automatic kitchen countertop device for converting recyclable bottles into redeemable coins or tokens formed in accordance with the present invention.

FIG. 2 is a cutaway perspective view of a lower portion of the device of the present invention shown in FIG. 1.

FIG. 3 is a cutaway perspective view of a lower portion of the device of the present invention shown in FIG. 1, and illustrating the device forming a coin or token.

FIG. 4 is a perspective view of a second embodiment of an automatic kitchen countertop device for converting recyclable bottles into redeemable coins or tokens formed in accordance with the present invention.

FIG. 5 is a top plan view of the device of the present invention shown in FIG. 4.

FIG. 6 is a side view of the device of the present invention shown in FIGS. 4 and 5.

FIG. 7 is a front view of the device of the present invention shown in FIGS. 4-6.

FIG. 8 is a longitudinal cross-sectional view of the device of the present invention shown in FIGS. 4-7 and taken along line A-A of FIG. 7.

FIG. 9 is a perspective view of the device of the present invention shown in FIGS. 4-8 and illustrating the lid of the device being open to accept beverage bottles.

FIG. 10 is a perspective view of the device of the present invention shown in FIGS. 4-9 and illustrating the generation of a coin after the beverage bottles received thereby are melted.

FIG. 11 is a perspective view of the device of the present invention shown in FIGS. 4-10 and illustrating further features of the device, including a bottle cap storage chute and a receptacle for receiving air filters.

FIG. 12 is a block diagram of one form of the electronic circuitry of the device for converting recyclable bottles into redeemable coins or tokens of the first embodiment shown in FIGS. 1-3 or the second embodiment shown in FIGS. 4-11.

FIG. 13 is a first software routine of an operational flow chart of the devices shown in FIGS. 1-3 and FIGS. 4-11.

FIG. 14 is a second software routine of an operational flow chart of the devices shown in FIGS. 1-3 and FIGS. 4-11.

FIG. 15 is a third software routine of an operational flow chart of the devices shown in FIGS. 1-3 and FIGS. 4-11.

FIG. 16 is a fourth software routine of an operational flow chart of the devices shown in FIGS. 1-3 and FIGS. 4-11.

FIG. 17 is a fifth software routine of an operational flow chart of the devices shown in FIGS. 1-3 and FIGS. 4-11.

FIG. 18 is a sixth software routine of an operational flow chart of the devices shown in FIGS. 1-3 and FIGS. 4-11.

FIG. 19 is a seventh software routine of an operational flow chart of the devices shown in FIGS. 1-3 and FIGS. 4-11.

### DETAILED DESCRIPTION OF THE PREFERRED EMBODIMENTS

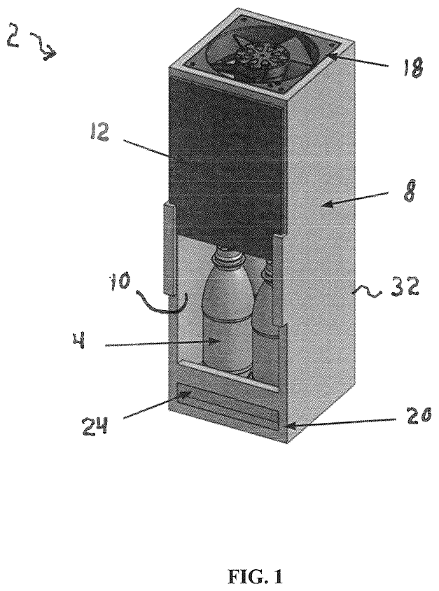

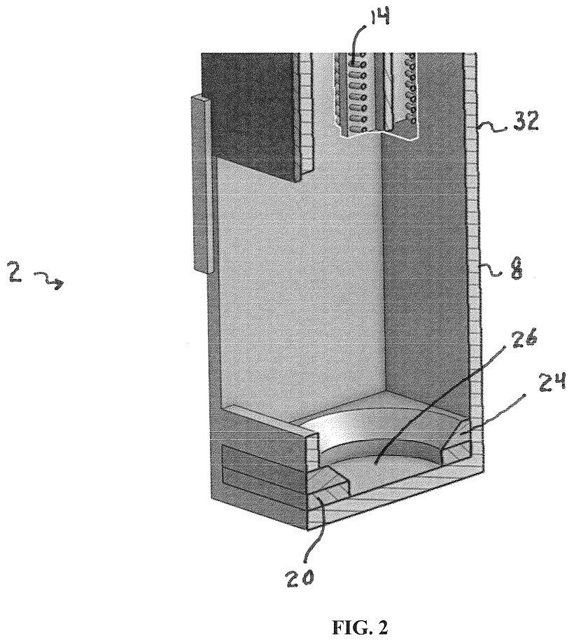

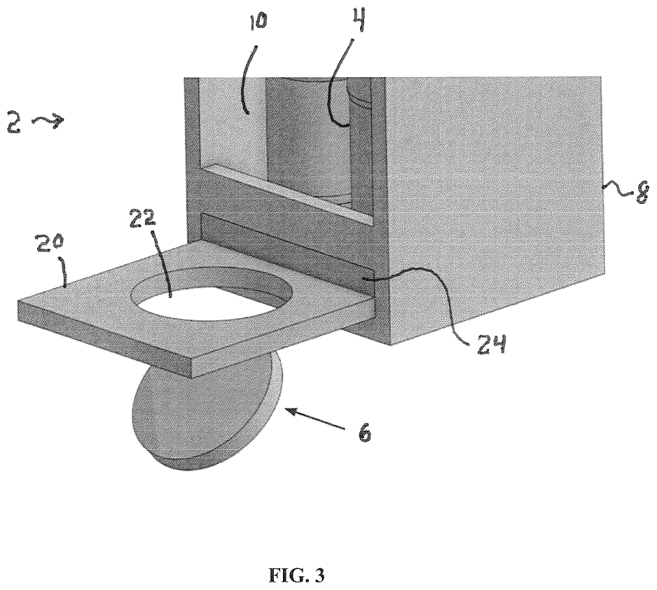

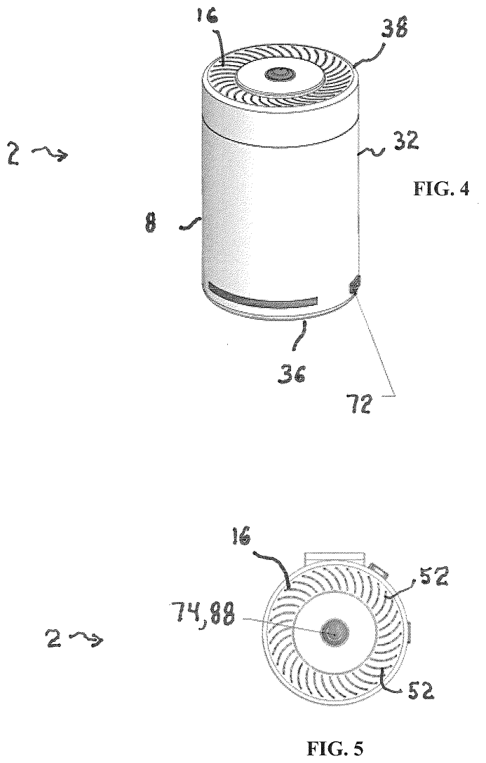

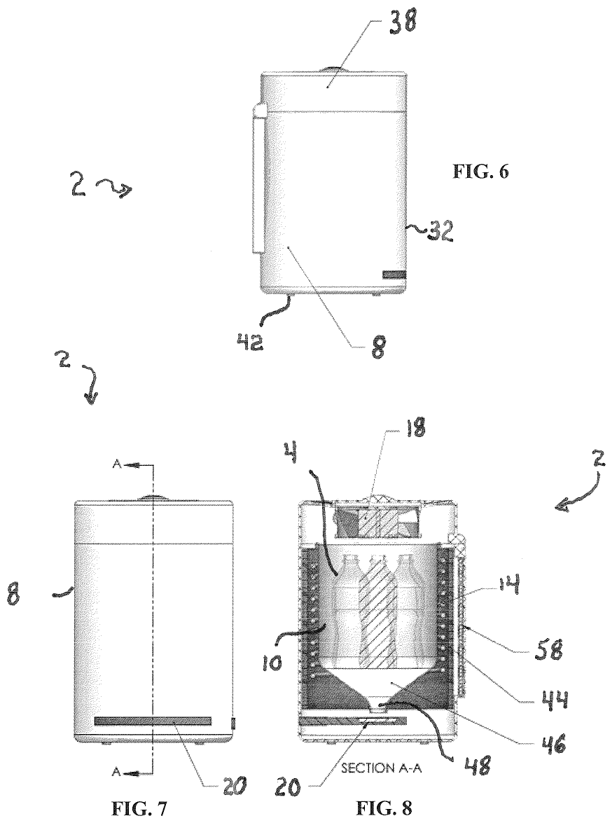

Referring initially to FIGS. 1-3 and FIGS. 4-11 of the drawings, it will be seen that an automatic kitchen countertop device 2 for converting recyclable plastic bottles 4 into redeemable coins 6 formed in accordance with a first embodiment (shown in FIGS. 1-3) and a second embodiment (shown in FIGS. 4-11) of the present invention preferably includes the following components:
A housing 8 which defines an insulated metal chamber 10: This is the primary space where used bottles 4 are placed for melting. The chamber 10 is made from a heat-resistant material, such as metal alloys used in industrial ovens. The housing 8 includes a vertically-translating door 12 which may be opened to insert used bottles 4 into the chamber 10 and closed during operation of the device 2 in melting the bottles 4;
One or more heating elements 14: The chamber 10 includes one or more heating elements 14 (e.g., electric coils) which are controlled by a thermocouple to maintain precise temperature conditions;
An air intake 16 and fan 18: A convection fan 18 is installed preferably at the top of the chamber 10 to circulate hot air for consistent heating therewithin;
A coin mold: At the base 36 of the chamber 10 is located a mold into which molten plastic may flow and which shapes the melted plastic into a token or coin. The mold preferably includes two parts—one removable (a coin tray 20 containing an open receptacle 22 for receiving molten plastic) and one static (e.g., a non-movable plate 24 situated above the receptacle 22 of the coin tray 20 and having an opening 26 formed through its thickness which has beveled interior sides defining the opening 26 and which acts as a funnel to direct molten plastic from the melted bottles 4 into the receptacle 22 of the coin tray 20)—to facilitate the release of the formed token; and
A filtration system: An air filter or filters 28 are included to avoid harmful fumes entering the environment of use.

The basis steps either performed by the user of the device 2 of the present invention or by the device 2 itself to melt plastic bottles 4 and form a redeemable coin or token are set forth below:
Loading bottles 4: The user opens a vertically-translating door 12 (or removable or hinged cover or lid 38 in the embodiment shown in FIGS. 4-11) and places one or more bottles 4 inside the insulated chamber 10;
Heating and melting: The heating element or elements 14 of the device 2 are activated, and hot air circulates within the chamber 10. The temperature is controlled by a thermocouple to ensure uniform heating of the plastic bottles 4 within the chamber 10. Once the bottles 4 reach the melting point, the molten plastic flows by gravity into the coin mold.

Cooling and token formation: After the molten plastic fills the mold, it is allowed to cool and solidify. A horizontally translating part of the mold (i.e., the coin tray 20) is then pulled out, enabling the token to drop from the open receptacle 22 of the tray 20 for retrieval.

Token retrieval: The user retrieves the cooled token from the base 36 of the machine 2.

The device 2 of the present invention may include various forms of user interfaces. For example, the device 2 could have a simple, single power-on or start button switch 74 to initiate the operation of the device 2. Alternatively, the device 2 may include a more complex interface with touchscreen displays or mobile app integration. The user selects the type of material being recycled (e.g. other plastic bottles 4 or plastic waste), and the device 2 adjusts the appropriate heating cycle accordingly.

The device 2 of the present invention further preferably includes a number of safety features, such as the following:
Temperature control: The device 2 may be equipped with a thermocouple for monitoring and regulating temperature, ensuring that the device 2 shuts off if it exceeds a safe threshold;
Redundant safety systems: The device 2 may include backup cutoff mechanisms to prevent overheating and potential fire hazards;
Child-lock mechanism: In some embodiments, the door or lid on the housing 8 of the device 2 may feature a locking system to prevent accidental use or energization of the device 2 by children.

The device 2 of the present invention is primarily designed to receive plastic bottles 4, but can be adapted to other materials such as aluminum cans. Variations in temperature cycles and mold designs could allow for multi-material recycling.

An enhanced form of the device 2 of the present invention may include a number of additional features which are set forth below:

Embedded RFID chips: To prevent fraud and ensure the tokens 6 are generated from legitimate recyclable materials, RFID chips could be embedded in the tokens 6 during the melting process. These chips could communicate with external systems to verify the source material.

Batch Processing: For energy efficiency, the device 2 could melt several bottles 4 at once, ensuring that less energy is used per token generated.

Multi-material capabilities: Additional settings could be programmed to handle different types of recyclables (e.g., pop cans), each with a tailored melting and cooling process.

Coin Authentication System: A scanning system that reads RFID or unique markings on tokens 6 could be integrated into the device 2 for verifying their authenticity when redeemed at recycling centers or exchange machines

In several alternative embodiments of the present invention, the device 2 may be constructed to rest on a countertop, or may be wall-mountable. More specifically, a countertop version of the device 2 may be compact in size, or a relatively larger, wall-mountable unit may be constructed for more frequent recycling. Additionally, the device 2 of the present invention may have a manually-operated or automatically-operated coin mold ejector mechanism. More specifically, in one embodiment of the present invention, the user of the device 2 manually pulls out the coin tray 20 for token retrieval. In another embodiment of the present invention, the device 2 automatically ejects the molded coin or token after cooling.

Reference should now be had to FIGS. 4-11 of the drawings, which show a second embodiment of the device 2 for converting recyclable bottles 4 into redeemable coins or tokens 6 formed in accordance with the present invention. The device 2 includes a housing 8 formed of an outer sidewall 32, an inner wall 34 spaced radially inwardly from the outer sidewall 32, a base 36 affixed to the bottom portion of the outer sidewall 32, and a hinged or removable top cover or lid 38 which is mounted on the upper portion of the outer sidewall 32 and which selectively covers and uncovers an open top end 40 of the inner wall 34. Preferably, the housing 8 has an overall cylindrical shape, with the outer sidewall 32 being cylindrical and the inner wall 34 being cylindrical and concentrically spaced within the outer sidewall 32. The cover or lid 38 is also cylindrical in overall shape, and preferably has an outer diameter which is the same as the outer diameter of the outer sidewall 32 of the housing 8. In a preferred form of the device 2, the outer sidewall 32 of the housing 8 and that of the cover 38 are formed from stainless steel, brushed aluminum or steel or impact and heat-resistant plastic for aesthetic purposes and durability.

As can be seen from FIGS. 7 and 8 of the drawings, the base 36 of the housing 8 includes a plurality of insulating feet 42, preferably rubberized, mounted on the outer surface of the base 36 at the underside of the housing 8 so that, in this embodiment, the device 2 may rest on a countertop or table without damaging its supporting surface. In another version of the device 2 in the present invention, a mounting bracket (not shown) may be affixed to the exterior surface of the outer sidewall 32 of the housing 8 so that the device 2 may be directly mounted to a wall of a home or office, for example, where the device 2 is being used, or may be indirectly mounted and removable from a corresponding bracket (not shown) for support that is affixed to the wall of the home or office.

As can be seen in FIG. 8 of the drawings, the device 2 includes thermal insulation 44 disposed between the outer sidewall 32 and the inner wall 34 to not only maintain heat within the device 2, as will be described in greater detail, but also as a safety measure to ensure that the outer sidewall 32 of the housing 8 remains cool or moderately warm to the touch.

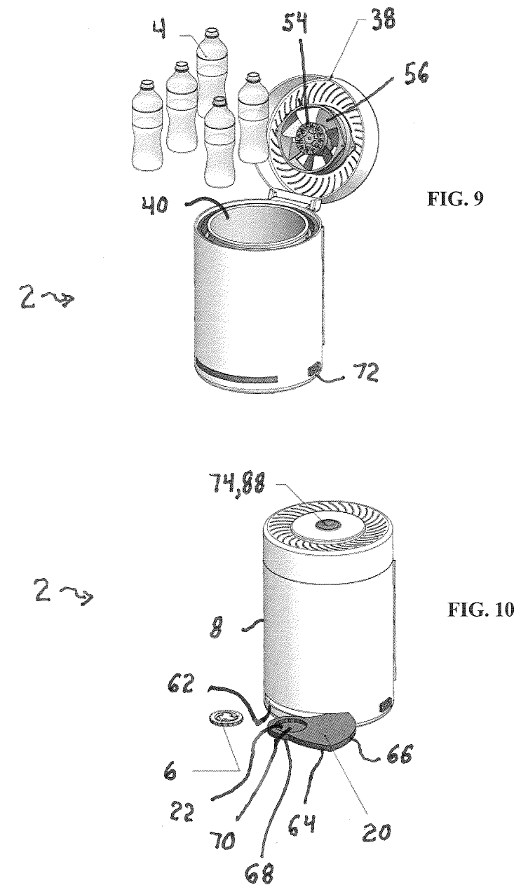

The inner wall 34 defines a chamber 10 therewithin for receiving recyclable bottles 4, such as shown in FIGS. 8 and 9 of the drawings, through the open top end 40 of the inner wall 34. The bottles 4 are arranged side-by-side and resting vertically upright within the chamber 10 defined by the inner wall 34 of the housing 8 in a preferred embodiment of the device 2. The inner wall 34 of the housing 8 may be cone-shaped at its lower portion 46 to define a funnel which is surrounded by insulation 44. A central opening 48 formed in the funnel-shaped lower portion 46 of the inner wall 34 of the housing 8 is situated directly above and in alignment with a coin receptacle 22 formed in a coin tray 20 so that any molten plastic resulting from the device 2 melting plastic bottles 4 received thereby will be directed by the funnel-shaped lower portion 46 to flow into the receptacle 22 of the coin tray 20 and form a token or coin made from the melted plastic which has cooled and solidified therein.

The lid or cover 38 of the housing 8 preferably includes an air intake 16 for outside air to enter through the cover 38 into the chamber 10 defined by the inner wall 34 of the housing 8. In one form, the air intake 16 may be a plurality of circumferentially spaced apart, curved, radially extending slots 52 formed through the thickness of the top wall of the cover 38, such as shown in FIGS. 4, 5 and 9-11 of the drawings. Also mounted to the top wall of the cover 38 is a fan 18 comprising a motor 54 and fan blades 56 affixed to the shaft of the motor 54 for the purpose of drawing air in through the air intake 16 and into the chamber 10 of the housing 8 where the bottles 4 to be melted are placed. The openings (slots 52) of the air intake 16 may be covered or uncovered (closed or opened) either manually by the user or automatically by the electronic circuitry 76 of the device 2, as will be explained in greater detail.

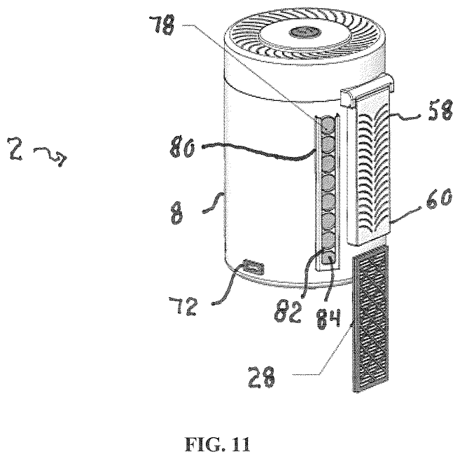

Preferably, an air outlet 58 is formed on the outer sidewall 32 of the housing 8. More specifically, and as shown in FIG. 11 of the drawings, the air outlet 58 may be one or more openings formed through the thickness of the outer sidewall 32 of the housing 8 and one or more openings formed through the thickness of the inner wall 34 of the housing 8, which inner wall 34 openings are in alignment with the outer wall openings so that heated air within the chamber 10 may be discharged through the air outlet 58 to the outside environment through the air outlet openings. The air outlet openings in one or both of the inner wall 34 and outer sidewall 32 may be covered or uncovered (closed or opened) manually by the user or automatically by the electronic circuitry 76 of the device 2, as will be explained in greater detail. With the fan 18 on and with the air intake openings and air outlet openings closed, the chamber 10 acts as a convention oven with the fan 18 circulating and distributing heated air throughout the chamber 10 to melt the plastic bottles 4. During the cooling process of the device's operation, the air intake openings and air outlet openings are opened so that ambient air is drawn into the chamber 10 through the air intake openings and the heated air in the chamber 10 is vented therefrom through the air outlet openings.

An air filter receptacle 60 is preferably formed as an elongated parallelepiped structure mounted on the exterior surface of the outer sidewall 32 of the housing 8 in alignment with the air outlet openings formed through the thickness thereof. The structure 60 defines a cavity for receiving a filter 28 which is inserted therein. As mentioned previously, the purpose of the filter 28 is to minimize or eliminate exposure to a user of the device 2 of any harmful emitted gases or particles given off by the device 2 when the device 2 is melting the plastic bottles 4.

A heater element, or elements 14, preferably formed of nichrome wire or the like, encircles the radially outer surface of the inner wall 34 of the housing 8 over at least a portion of the axial length thereof and situated on the radially inner side of the insulation 44 disposed between the outer sidewall 32 and the inner wall 34 of the housing 8. The heater element 14 is selectively energizable to generate heat, which is conducted through the inner wall 34 of the housing 8 and into the chamber 10 in which the plastic bottles 4 are placed.

As mentioned previously, the device 2 of the present invention includes a coin tray 20. In one form, a slot 62 is formed in the bottom portion of the outer sidewall 32 of the housing 8 and over an arcuate portion of the circumference thereof, the slot 62 receiving the coin tray 20 therein. The slot 62 is formed with a height that is slightly greater than the thickness of the coin tray 20, as shown in FIG. 10 of the drawings.

The coin tray 20 is formed as a planar member generally triangular in shape and having a main body portion 64 with an arcuate outer surface 66 that preferably matches the outer diameter of the outer sidewall 32 of the housing 8. In a preferred form of the device 2, when the coin tray 20 is fully received by the slot 62, the outer arcuate surface of the tray 20 extends fully across the width of the slot 62 to essentially seal the slot 62. A rounded apex portion 68 of the generally triangular-shaped coin tray 20 opposite the arcuate outer surface 66 of the main body portion 64 of the tray 20 is formed with a receptacle 22 defined by a recessed circular portion of the upper surface of the coin tray 20 and a bottom wall 70 located within the receptacle 22. The receptacle 22 is provided in the coin tray 20 for receiving molten plastic from the melted bottles 4 that are directed by the funnel-shaped lower portion 46 of the inner wall 34 of the housing 8, the opening 48 in the funnel-shaped portion being directly in alignment with the receptacle 22 of the coin tray 20, as shown in FIG. 8 of the drawings, when the coin tray 20 is fully received within the slot 62 of the housing 8. The coin tray 20, at one edge of the main body portion 64 thereof, is pivotally mounted to the housing 8 so that it may swing inwardly and outwardly through the slot 62 formed in the outer sidewall 32 of the housing 8. Alternatively, the coin tray 20 may slide radially into the slot 62 and be removable therefrom. When the molten plastic filling the receptacle 22 of the coin tray 20 has cooled sufficiently and solidified, a recyclable coin is formed therefrom, which resides in the receptacle 22 of the coin tray 20. The coin tray 20 may be opened manually by the user of the device 2, or may slide or pivot outwardly automatically by a spring loaded mechanism (not shown) released by the device 2 so that a user of the device 2 may remove the formed recyclable coin or token from the coin tray 20 for exchange for cash or credit at a redemption center or store.

The general operation of the device 2 for converting recyclable bottles 4 into redeemable coins or tokens 6 formed in accordance with the present invention will now be described. An electrical power cord (not shown) is plugged into a power socket 72 mounted on the outer sidewall 32 of the device 2 when the device 2 is ready to be used. The lid or cover 38 of the housing 8 is either removed or pivoted upwardly on a hinge connecting the cover 38 to the outer sidewall 32 of the housing 8 so that the recyclable bottles 4 to be melted may be placed within the chamber 10 through the open top end 40 of the inner wall 34 of the housing 8, as shown in FIG. 9 of the drawings. The cover 38 is then closed when the chamber 10 receives the recyclable bottles 4. FIG. 9 of the drawings shows by way of example only five bottles 4 being received by the chamber 10 of the device 2; however, it is envisioned to be within the scope of the present invention to have a fewer or a greater number of bottles 4 received by the chamber 10 at one time.

The user then activates a start switch 88, which may be the power-on push button switch 74 preferably mounted centrally on the top wall of the cover 38. Depressing the push button start switch 88 will initialize the electronic circuitry 76, as will be described in greater detail, which will conduct a safety check of sensors and will turn on the fan 18 (for convection heating) and heating element or elements 14 of the device 2. Heat generated by the heating elements 14 within the chamber 10 will reach a desired temperature, causing the plastic bottles 4 to melt into a molten form. The molten plastic will flow through the chamber 10 and into the funnel-shaped lower portion 46 of the inner wall 34 and through the opening 48 formed therein, and will be directed into the receptacle 22 of the coin tray 20. The electronic circuitry 76 will control the heating element 14 and, in one preferred form, after a predetermined time has elapsed, will deenergize the heating element 14 but keep the fan 18 on and open the air intake 16 and air outlet 58 to allow the molten plastic filling the receptacle 22 of the coin tray 20 to solidify into a plastic coin or token. After the coin or token has cooled sufficiently, the electronic circuitry 76 will shut off the fan 18 and unlock the coin tray 20 so that the tray 20 may be pivoted or slid outwardly of the outer sidewall 32 of the housing 8 either manually or automatically so that the user may remove the formed coin or token from the coin tray 20.

As shown in FIG. 11 of the drawings, it can be seen that the air filter 28 may be periodically replaced from the filter structure 60. Furthermore, in a preferred form of the device 2 of the present invention, a bottle cap storage chute 78, preferably formed with parallel L-shaped and spaced apart sidewalls 80 which together define an open slot 82 accessible by a user of the device 2, may be mounted on the exterior surface of the outer sidewall 32 of the housing 8 and provided for receiving bottle caps 84 removed from the recyclable bottles 4 prior to their being placed in the chamber 10 of the device 2 for melting.

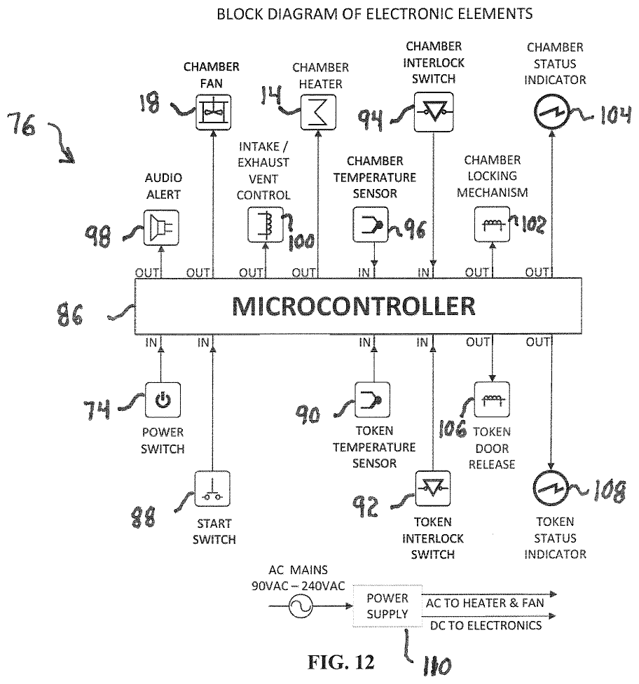

Reference should now be had to FIG. 12 of the drawings, which shows in one form of the present invention a block diagram of the electronic elements and circuitry 76 of the device 2. Control over the heating element 14, fan 18, and sensors, and other components of the device 2, is provided by a microcontroller 86. The microcontroller 86 receives input signals from various components of the device 2 and provides output signals to control other components of the device 2.

For example, input signals from the power switch 74, a start switch 88 (if included), a token temperature sensor 90, a token interlock switch 92, a chamber 10 interlock switch, and a chamber 10 temperature sensor are provided to the microcontroller 86. In response to one or more of the input signals received by the microcontroller 86, the microcontroller 86 sends output signals to the various components of the device 2, including an audio alert indicator 98, the chamber fan 18, an intake/exhaust vent control mechanism 100, if such is provided, the chamber heater element or elements 14, a chamber locking mechanism 102 which prevents the cover or lid 38 from being opened, a chamber status indicator 104, a token door release mechanism 106 which controls whether the coin tray 20 may be opened by the user or automatically opened by the device 2, and a token status indicator 108. Furthermore, FIG. 12 indicates that normal household voltage or two phase line voltage (90 VAC-240 VAC) is provided to a power supply 110 internally situated within the device 2, which power supply 110 provides an AC voltage to the heater and fan 18 and a DC voltage to the control electronics. The function and operation of each of the sensors and other elements controlled by the electronic circuitry 76 of the device 2 is set forth in greater detail in Table I, shown below:

TABLE I
Bottle Recycling Machine Component Descriptions

| | | Signal | |
|---|---|---|---|
| ID | Component | Direction | Description |
| 86 | Micro- | Input/ | Executes software to control operation of the Bottle |
| | controller 86 | Output | Recycling Machine 2. |
| 96 | Chamber | Input | This sensor allows the temperature of the chamber 10 to be |
| | Temperature | | determined so that the Microcontroller 86 can regulate the |
| | Sensor 96 | | temperature in the chamber 10 by controlling the Chamber |
| | | | Heater, Chamber Fan 18 and Intake/Exhaust Vent Control. |
| 94 | Chamber Interlock | Input | As a safety mechanism, this switch is used to detect that the |
| | Switch 94 | | chamber access door (lid or cover 38) is securely locked. |
| 18 | Chamber Fan 18 | Output | With the intake and exhaust vents closed, this fan 18 |
| | | | circulates air within the chamber 10 to generate high enough |
| | | | temperatures by convection to melt the plastic. |
| | | | With the intake and exhaust vents open, fresh air can flow |
| | | | through the chamber 10 and token area to aid in cooling. |
| | | | Driver electronics are preferably included to interface the |
| | | | microcontroller output to the fan 18 and control its speed. |
| | | | Speed control can be achieved through a Pulse Width |
| | | | Modulated (PWM) signal generated by the microcontroller |
| | | | 86 or other speed control mechanism. |
| 14 | Chamber | Output | A heating element 14 to melt the plastic bottles 4. Driver |
| | Heater 14 | | electronics are preferably included to interface the |
| | | | Microcontroller output to the heating element 14. |
| 102 | Chamber Locking | Output | When activated, this mechanism securely locks the chamber |
| | Mechanism 102 | | door (lid or cover 38) so that the user cannot inadvertently |
| | | | open it when the unit is running. |
| | | | Driver electronics are preferably included to interface the |
| | | | microcontroller output to actuate a solenoid or similar |
| | | | device 2 to latch or unlatch the door lock. |
| 104 | Chamber Status | Output | A method of indicating the status inside the chamber 10. |
| | Indicator 104 | | This might be a tri-color LED indicating states or error |
| | | | conditions associated with the chamber 10 (e.g., Green for |
| | | | “Ready”, Red for “Heating”, Blue for “Cooling”, Flashing |
| | | | Red for “Door Open”, etc.). |
| | | | This can also be implemented with an LCD panel or other |
| | | | means of communicating status. |
| 90 | Token Temperature | Input | This sensor allows the temperature of the token area to be |
| | Sensor 90 | | determined so that the Microcontroller 86 can detect when |
| | | | hot plastic has entered the token area and when it is cool |
| | | | enough to be safely ejected to the user. |
| 92 | Token Interlock | Input | As a safety mechanism, this switch is used to verify that the |
| | Switch 92 | | token or coin tray 20 is securely locked within its receiving |
| | | | slot 62. |
| 106 | Token Tray | Output | When active, a spring-loaded coin or token tray 20 |
| | Release 106 | | containing the cooled token is released by a token tray |
| | | | release mechanism 106 to project outwardly from the slot |
| | | | 62 so that the token may be retrieved therefrom by the user. |
| | | | Once opened, the coin or token tray 20 may be manually |
| | | | retracted into the slot 62 by the user pushing on the tray 20 |
| | | | whereupon it is relatched in a closed position by the token |
| | | | tray release mechanism 106. |
| 108 | Token Status | Output | A method of indicating the status inside the token area. This |
| | Indicator 108 | | might be a tri-color LED indicating states or error |
| | | | conditions associated with this area (e.g., Green for |
| | | | “Ready”, Red for “Hot Token”, Blue for “Cooling”, |
| | | | Flashing Green for “Token is Ready”, Flashing Red for |
| | | | “Need to Close Token Tray”, etc.). |
| | | | This can also be implemented with an LCD panel or other |
| | | | means of communicating status. |
| | | | The “Audio Alert” indicator 98 can also sound to indicate |
| | | | important conditions such as when the token is being |
| | | | dispensed or if there is an error condition. |
| 74 | Power Switch 74 | Input | When plugged in, the Bottle Recycling Machine 2 enters a |
| | | | low-power “Off” state awaiting this button to be pushed. |
| | | | When pushed, a power up procedure is run (to initialize and |
| | | | perform self-test) and the device 2 enters a “Ready” state. |
| | | | If the Bottle Recycling Machine 2 has turned on its heater, a |
| | | | “long-press” of this button will cause the Bottle Recycling |
| | | | Machine 2 to go through a cooling procedure (and possibly |
| | | | ejecting a partially formed token) before entering the “Off” |
| | | | state. |
| 88 | Start Switch 88 | Input | When in the “Ready” state, a press of this button (if |
| | | | included) will cause the Microcontroller 86 to execute the |
| | | | firmware that initiates the bottle melting process. If this |
| | | | switch is not included in the device 2, the power switch 74 |
| | | | may perform this function. |
| | | | If this process is already in progress, then a long press of |
| | | | this button will cause the current process to be cancelled |
| | | | and the system to be cooled down (and possibly ejecting a |
| | | | partially formed token) before entering the “Ready” state. |
| 100 | Intake/Exhaust | Output | This is a solenoid, a stepper motor, or similar device 2 that |
| | Vent Control 100 | | the Microcontroller 86 controls to vary the amount of fresh |
| | | | air entering into the chamber 10 and token area as a means |
| | | | of cooling these areas. |
| | | | Driver electronics are preferably included to interface the |
| | | | Microcontroller output with the Intake/Exhaust Vent |
| | | | Control 100. |
| 98 | Audio Alert 98 | Output | The audio alert 98, which may be a speaker, buzzer, piezo |
| | | | electric or similar device 2, provides an audio indication to |
| | | | notify the user of system progress or error conditions. |
| 110 | Power Supply 110 | Output | The power supply 110 takes in the AC power from the |
| | | | Mains (in the range of 90 VAC-250 VAC) and produces |
| | | | DC voltages suitable for the Microcontroller 86 and |
| | | | associated electronics. |
| | | | The power supply 110 is also responsible for providing |
| | | | other DC and/or AC voltages that may be needed by |
| | | | electrical components such as heating elements 14, fan 18, |
| | | | and solenoids. |

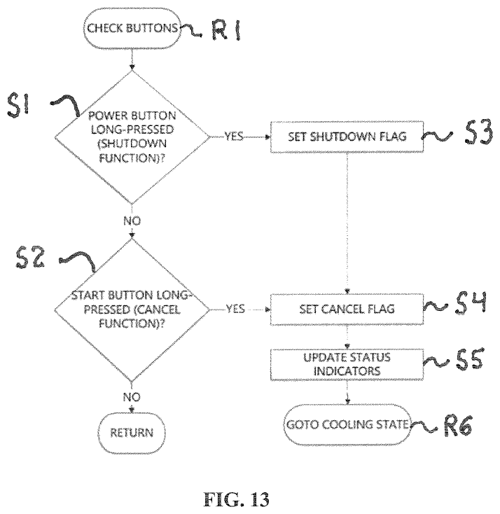

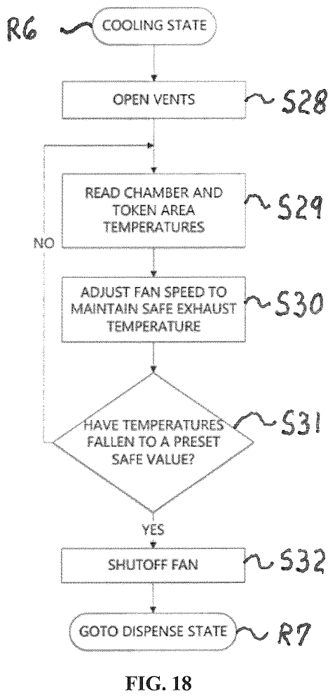

A flow chart of the operation of the device 2 and electronic circuitry 76 thereof is depicted in the various software routines shown in FIGS. 13-19 of the drawings. More specifically, a “check buttons” routine R1 is shown in FIG. 13 for checking the status of the power push button switch 74 and the start switch 88 (if such is included). More specifically, in this routine, the power-on push button switch 74 is polled (Step S1) and the start push button switch, if provided, is polled (Step S2) by the microcontroller 86. If the power button push button switch 74 is pushed momentarily, a powerup procedure is run by the electronic circuitry 76 to initialize and perform a self-test and enter a ready state, as described in Table I. However, if the power switch 74 is held for at least a predetermined period of time (“long-pressed”) and if the device 2 has already turned on its heater element or elements 14, the electronic circuitry 76 will generate a “shut down” flag (Step S3) and “cancel” flag (Step S4), and update any status indicators (Step S5), and go through a cooling procedure (“cooling state” routine R6 shown in FIG. 18), including shutting the heating elements 14 off and allowing the fan 18 to remain energized, before entering the off state.

However, if the power push button switch 74 is only momentarily pushed (Step S1), initialization procedures will continue. The electronic circuitry 76 will also poll the start push button switch, if provided on the device 2, and determine if the switch was momentarily pressed or pressed for at least a predetermined period of time (“long-pressed”) (Step S2). If the start push button switch is pressed other than momentarily, the electronic circuitry 76 will generate a cancel flag (Step S4), cancelling the operation of the device 2, and update the status indicators (Step S5) and go into a cooling procedure (the “cooling state” routine R6), as set forth in Table I.

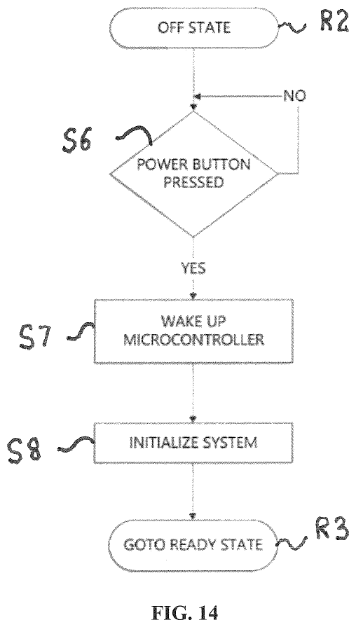

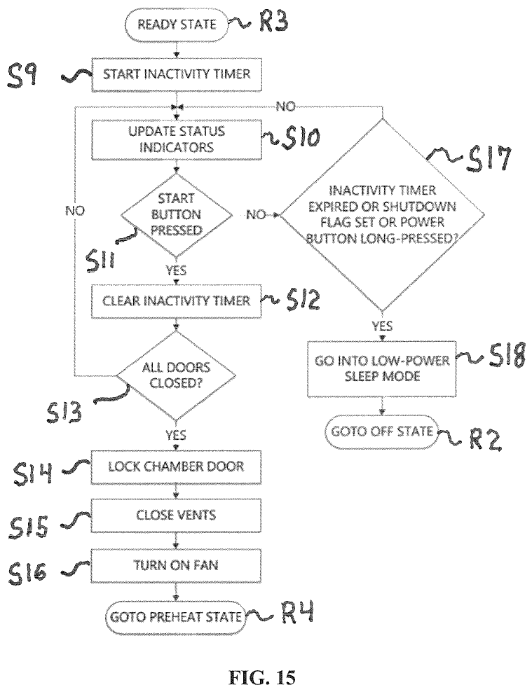

FIG. 14 illustrates the operational “off state” routine R2 of the electronic circuitry 76 and device 2 when the device 2 is being started from an off state. The electronic circuitry 76 continually polls the power push button switch 74 to determine if it was pressed (Step S6). If the power push button switch 74 was pressed by the user, then the microcontroller 86 “wakes up” from a sleep state (Step S7) and begins to initialize the electronic circuitry 76 and components of the device 2 (Step S8), and enters the “ready state” routine R3 shown in FIG. 15 of the drawings.

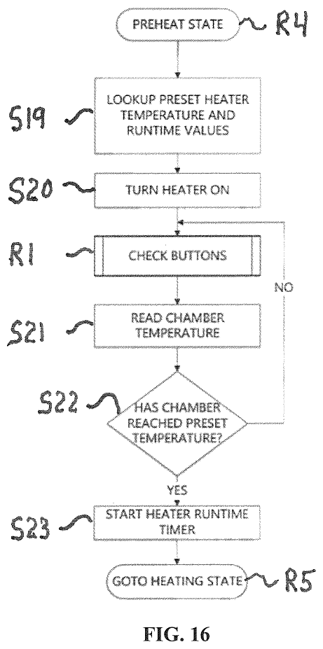

The “ready state” routine R3 followed by the electronic circuitry 76, when entered, starts an inactivity timer (Step S9) and will update any status indicators on the device 2 (Step S10). The electronic circuitry 76 will poll the start push button switch to determine if it was pressed (Step S11). If it was pressed within a predetermined period of time generated by the inactivity timer, then the inactivity timer is cleared (Step S12) and certain safety features on the device 2 are checked and activated. For example, the electronic circuitry 76 checks to see if the coin tray door is closed (meaning that the coin tray 20 is fully inserted into its receiving slot 62 in the housing 8 of the device 2) and the lid or cover 38 is closed (Step S13). If the cover 38 is closed and the coin tray 20 is fully received within its corresponding slot 62, then the electronic circuitry 76 locks the chamber door (i.e., the lid or cover 38) to prevent it from being opened inadvertently or on purpose (Step S14), closes the air intake vent 16 and air outlet vent 58 (Step S15), and turns on the fan 18 (Step S16). The electronic circuitry 76 then enters the “preheat state” routine R4 shown in FIG. 16 of the drawings.

However, if not all the doors are closed (i.e., one or both of the cover 38 or the coin tray 20 is open) (Step S13), the electronic circuitry 76 of the device 2 will update the status indicators (Step S10) and continue through the routine loop including polling the start push button switch to determine if it was pressed (Step S11), maintaining the inactivity timer as being cleared (Step S12) and determining if the coin tray 20 is fully retracted and/or the cover or lid 38 is closed (Step S13).

If the start push button switch was not pressed (Step S11) but the power push button switch 74 is pressed longer than momentarily or if the inactivity timer has expired, or the shut down flag has been set (Step S17), the electronic circuitry 76 will proceed into a low power sleep mode (Step S18) and go to the “off state” routine R2 shown in FIG. 14 of the drawings.

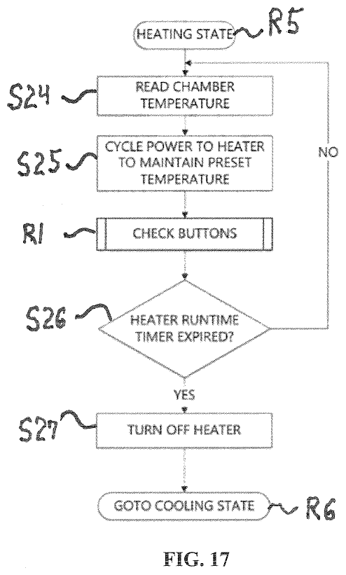

As mentioned previously, the “preheat state” routine R4 of the electronic circuitry 76 and device 2 is shown in FIG. 16 of the drawings. Here, the microcontroller 86 of the electronic circuitry 76 will look up the preset heater temperature and run time values stored in its memory (Step S19) and will energize the heater element 14 to generate sufficient heat within the chamber 10 to melt plastic bottles 4 within the chamber 10 (Step S20). The microcontroller 86 will then poll the push button power switch 74 (Step S1) and the push button start switch 88 (Step S2), if provided on the device 2, in the “check buttons” routine R1 shown in FIG. 13. If there have been no changes in the push button switches which would cause the preheat state routine R4 to change, then the microcontroller 86 will read the chamber temperature from the temperature sensor (Step S21) and determine if the chamber 10 has reached a preset temperature (Step S22). If it has, then the microcontroller 86 will start a heater runtime timer (Step S23) and will go to the “heating state” routine R5 shown in FIG. 17 of the drawings. However, if the chamber 10 has not reached its preset temperature (Step S22), the electronic circuitry 76 will loop back to the “check buttons” routine R1 shown in FIG. 13 and check the status of the push button power switch 74 (Step S1) and the push button start switch 88 (Step S2), if such is included in the device 2.

The “heating state” routine R5 of the operation of the microcontroller 86 and the device 2 is shown in FIG. 17 of the drawings. Here, the microcontroller 86 will read the chamber temperature (Step S24) and will cycle power to the heater element or elements 14 on and off to maintain the preset temperature (Step S25). Again, the electronic circuitry 76 will continually monitor the status of the push button power switch 74 (Step S1) and the push button start switch 88 (Step S2) in the “check buttons” routine R1 shown in FIG. 13.

If the predetermined time on the heater runtime timer of the microcontroller 86 has expired (Step S26), then the microcontroller 86 turns off (i.e., deenergizes) the heater element or elements 14 (Step S27) and goes to the “cooling state” routine R6 shown in FIG. 18 of the drawings. However, if the predetermined runtime of the heater runtime timer has not expired (Step S26), then the microcontroller 86 and electronic circuitry 76 of the device 2 will loop back to the beginning of the “heating state” routine R5 and continually read the chamber temperature (Step S24) and cycle the power to the heater element or elements 14 on and off to maintain the preset temperature (Step S25), and also will continue to check the status of the push button power switch 74 (Step S1) and the push button start switch 88 (Step S2) in the “check buttons” routine R1 shown in FIG. 13 of the drawings.

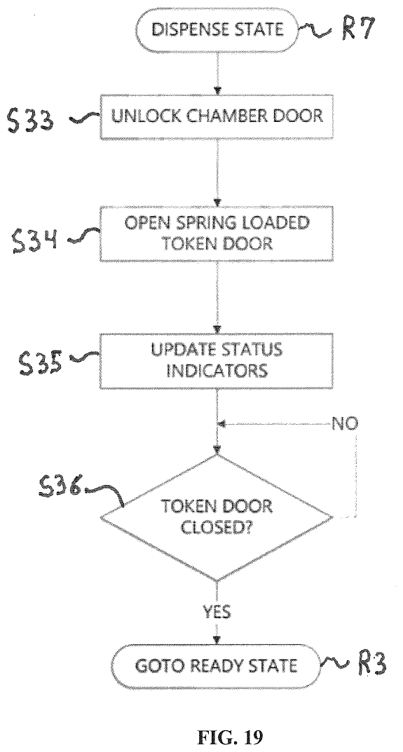

As mentioned above, the “cooling state” routine R6 followed by the electronic circuitry 76 and microcontroller 86 thereof is shown in FIG. 18 of the drawings. Here, the microcontroller 86 causes the air intake vent 16 and air outlet vent 58 to open (Step S28). The microcontroller 86 of the electronic circuitry 76 will then read the chamber temperature and token or coin area temperature provided to the microcontroller 86 from the temperature sensors located thereat (Step S29). If necessary, the electronic circuitry 76 will adjust the fan speed to maintain a safe exhaust temperature so that the user of the device 2 will not be harmed or burned by an exhaust temperature which may be too high (Step S30). The electronic circuitry 76 then determines whether the chamber temperature and the token or coin area temperature near the coin tray 20 have fallen to a preset safe value (Step S31). If they have, then the microcontroller 86 of the electronic circuitry 76 of the device 2 will shut the fan 18 off (Step S32) and will go to the “dispense state” routine R7 shown in FIG. 19 of the drawings. However, if the temperature in either the internal chamber 10 or the token area is still above a preset safe value (Step S31), then the microcontroller 86 will loop back in the routine R6 to continue to read the temperatures of the chamber 10 and the token area (Step S29) and adjust the fan speed, if necessary, to maintain a safe exhaust temperature (Step S30) until the aforementioned temperatures have both fallen to a preset safe value (Step S31).

Turning now to FIG. 19, the “dispense state” routine R7 of the electronic circuitry 76 and device 2 of the present invention is shown. Here, the microcontroller 86 causes the chamber door (i.e., the lid or cover 38) to unlock so that the lid or cover 38 may be raised or removed (Step S33). The microcontroller 86 also unlatches the token tray 20 from its closed state so that it may be opened manually by the user or automatically by the device 2 so that the coin or token tray 20 extends outwardly from its receiving slot 62 on the housing 8 (Step S34). More specifically, and as mentioned previously, the coin tray 20 may be spring loaded. When the coin tray latch is unlocked by the electronic circuitry 76 and microcontroller 86 thereof, the coin tray 20 will pivot or slide outwardly from the housing 8 of the device 2 under the bias of a spring (not shown). With the coin or token tray 20 in a fully extended state, the user of the device 2 may now remove from the receptacle 22 of the tray 20 the formed coin or token for later redemption, and push the tray 20 back into the tray slot 62. The microcontroller 86 will then update all of the status indicators of the device 2 (Step S35) and will check to see if the token door (i.e., the coin tray 20) is closed (that is, the coin tray 20 is fully retracted into its corresponding slot 62) (Step S36). If the coin tray 20 is fully retracted, then the microcontroller 86 will return to the “ready state” routine R3 shown in FIG. 15 of the drawings. However, if the coin tray 20 remains in an outwardly extended state from the housing 8 (Step S36), then the microcontroller 86 will continually loop back to determine if the coin tray 20 is fully pushed back into its receiving slot 62 before returning to the “ready state” routine R3.

It is envisioned that the plastic token that is generated by the device 2 of the present invention may constitute a form of currency which may be redeemed for cash or credit or used to purchase items.

The device 2 of the present invention alleviates the frustrations encountered by consumers when redeeming deposits on plastic bottles 4 in accordance with conventional bottle recycling programs by allowing the consumer to reduce the recyclable bottles 4 to a redeemable token or coin of small size which may be more easily carried or even mailed to a redemption center, thus eliminating the need to transport an accumulated quantity of bottles 4 to a compacting device 2 at a remote location. It is anticipated that the device 2 of the present invention will achieve the goals of environmental programs for recycling plastic material by inducing consumers to recycle plastic containers rather than discarding them as trash.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A device for converting recyclable bottles into redeemable coins or tokens, which comprises:
a housing, the housing including:
an outer sidewall, the outer sidewall having an upper portion and a lower portion disposed opposite the upper portion;
an inner wall situated interiorly of the outer sidewall, the outer sidewall and the inner wall defining a space therebetween, the inner wall defining a heating chamber for melting recyclable bottles received by the heating chamber, the inner wall having an open top end in communication with the heating chamber and a funnel-shaped lower portion disposed opposite the open top end, the funnel-shaped lower portion of the inner wall having an opening formed through a thickness thereof, the opening being in fluid communication with the heating chamber defined by the inner wall;
a base mounted on the lower portion of the outer sidewall; and
a cover hingedly affixed to or removably mounted on the upper portion of the outer sidewall to selectively cover and uncover the open top end of the inner wall;
wherein the device further comprises:
at least one heating element disposed within the space defined by and between the outer sidewall and the inner wall, the at least one heating element being selectively energizable to generate heat which is conducted through the inner wall and into the heating chamber;
thermal insulation disposed in the space defined by and between the outer sidewall and the inner wall, the thermal insulation being situated at least between the outer sidewall and the at least one heating element; and
a coin or token tray, the coin or token tray being receivable by a slot formed through a thickness of the lower portion of the outer sidewall and being selectively positionable in an extended state in which the coin or token tray extends at least partially out of the slot formed in the outer sidewall, and a retracted state in which the coin or token tray is at least partially retracted within the slot formed in the outer sidewall, the coin or token tray having an upper surface, a portion of the upper surface being recessed to define a receptacle for receiving molten material from melted recyclable bottles received by the heating chamber, the molten material received by the receptacle of the coin or token tray, when solidified, forming a coin or token which is removable from the coin or token tray by a user of the device when the coin or token tray is in the extended state, the coin or token tray, when in the retracted state, is positioned within the housing such that the receptacle of the coin or token tray is in alignment and fluid communication with the opening formed in the funnel-shaped lower portion of the inner wall to receive therein molten material from melted bottles in the heating chamber flowing through the opening of the funnel-shaped lower portion of the inner wall.

2. A device as defined by claim 1, which further comprises:
a fan, the fan being mounted on the housing, the fan being selectively energizable and recirculating air within the heating chamber when the fan is energized.

3. A device as defined by claim 1, which further comprises:
a fan mounted on the housing, the fan being selectively energizable;
an air intake having at least one opening disposed on the housing; and
an air outlet having at least one opening disposed on the housing;
wherein, when energized, the fan causes air from outside the housing to flow through the air intake into the heating chamber and air within the heating chamber to flow through the air outlet to outside the housing.

4. A device as defined by claim 3, which further comprises:
an air filter holder, the air filter holder being mounted on the housing in alignment with the air outlet, the air filter holder defining a cavity for receiving an air filter.

5. A device as defined by claim 3, which further comprises:
electronic circuitry, the electronic circuitry being housed within or on the housing and selectively energizing the at least one heating element and the fan.

6. A device as defined by claim 1, which further comprises:
electronic circuitry, the electronic circuitry being housed within or on the housing and selectively energizing the at least one heating element.

7. A device as defined by claim 1, which further comprises:
a bottle cap storage chute, the bottle cap storage chute being formed with parallel L-shaped and spaced apart sidewalls which together define an open slot accessible by the user of the device, the bottle cap storage chute being mounted on the housing and provided for receiving bottle caps removed from the recyclable bottles prior to the bottles being placed in the heating chamber of the device for melting.
